(19) United States
(12) Patent Application Publication
(10) Pub. No.: US 2021/0052932 A1
(43) Pub. Date: Feb. 25, 2021

(54) MoonWeight

(71) Applicant: Manuel Mazissa Gomes, York, PA (US)

(72) Inventor: Manuel Mazissa Gomes, York, PA (US)

(21) Appl. No.: 16/429,010

(22) Filed: Jun. 2, 2019

(51) Int. Cl. A63B 21/065; A63B 21/06

(52) U.S. Cl. CPC A63B 21/065; A61H 19/50; A63B 21/0604

(57) ABSTRACT

For this invention I took into account two basic aspects: the application of fitness equipment and how we can enjoy better the sexual activity

The main objective of the MoonWeight is to increase the weight of the body, in the man or in the woman during the sexual activity. Weight is important in both men and women to enjoy sex better in a relationship. Another application will be used as fitness equipment. The MoonWeight will be made of different weights and dimensions. The material will be metal. The MoonWeight will have a cover bag with sponge inside.

### TECHNICAL FIELD

The technical field of invention is fitness equipment and it is relates to MoonWeight.

### BACKGROUND OF THE INVENTION

Physical activity today is done in different ways, with simple equipment and even with complex equipment. There are many products to be able to exercise the body. The physical exercises with these equipment allow us better our physical mental and spiritual health. But it also has another importance that many people usually seek, is to become a sexy person mainly in men. That is an important factor to better enjoy sexual activity. But there is another fundamental element necessary it is the weight in the man or in the woman. So to increase the weight of both you can use the MoonWeight a new product specifically for that purpose and thus enjoy better sex. The way to use it is only to place it on the back as if it were a backpack. Another application of MoonWeight will be used as fitness equipment.

### BRIEF SUMMARY OF THE INVENTION

The main objective of the MoonWeight is to increase the weight of the body, in the man or in the woman during the sexual activity. Weight is important in both men and women to enjoy sex better in a relationship. Another application will be used as fitness equipment. The MoonWeight will be made of different weights and dimensions. The material will be metal. The MoonWeight will have a cover bag with sponge inside.

### BRIEF DESCRIPTION OF THE SEVERAL VIEWS OF THE DRAWING

FIG. 1 is a three-dimensional view of MoonWeight

FIG. 2 is a top view of belts.

FIG. 3 is a three-dimensional view of the cover sponge bag.

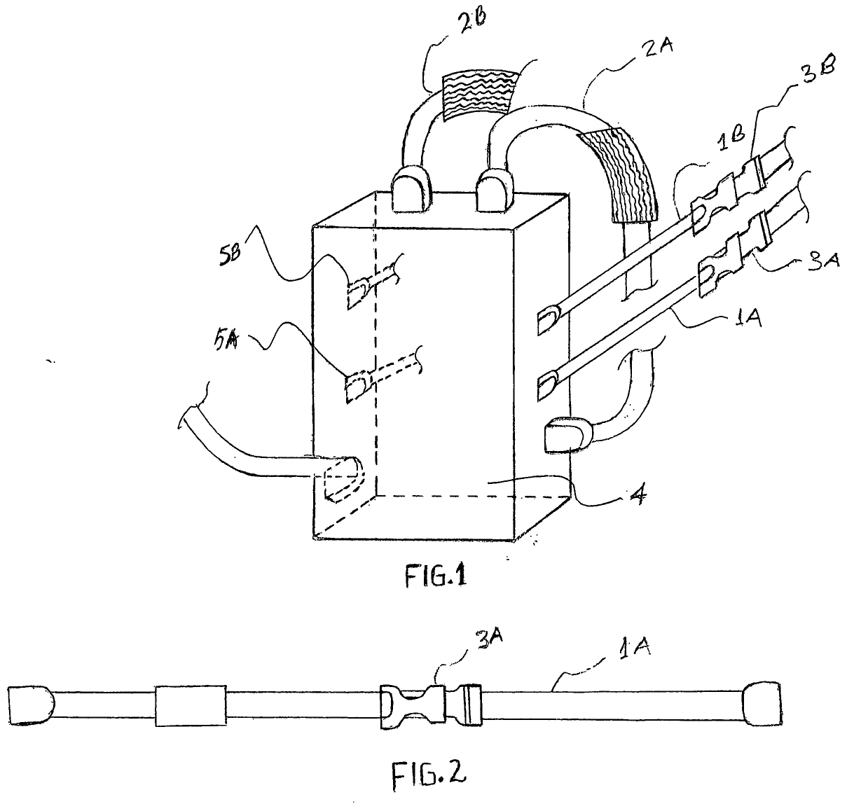

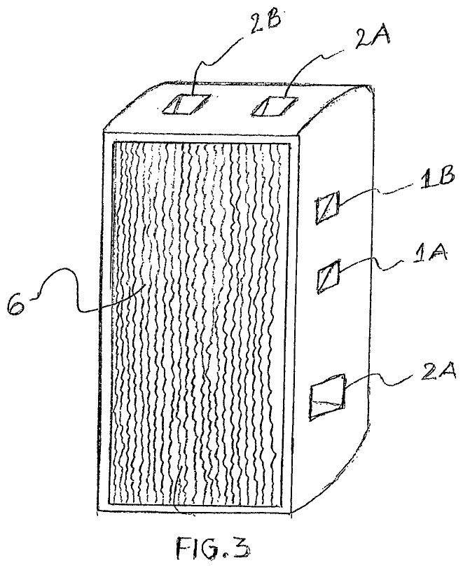

### DETAILED DESCRIPTION OF THE INVENTION

The MoonWeight 4 is a unique piece that will be placed inside a cover sponge bag 6. It will have two pairs of belts 2A y 2B and also two adjust belts 1A y 1B that have two connection points 3A y 3B. The adjust belts 1A y 1B are like the life jacket belts. The points 3A y 3B are tighten points of belts.

1. The ornamental design for MoonWeight, as well as for the cover sponge bag, as shown and described.
